(19) United States
(12) Patent Application Publication
(10) Pub. No.: US 2011/0075291 A1
(43) Pub. Date: Mar. 31, 2011

(54) DISK DRIVE CONTROLLED TO DETECT HEAD-DISK INTERFERENCE

(75) Inventor: Hyung-joon CHO, Suwon-si (KR)

(73) Assignee: SAMSUNG ELECTRONICS CO., LTD., Suwon-si (KR)

(21) Appl. No.: 12/882,524

(22) Filed: Sep. 15, 2010

(30) Foreign Application Priority Data
Sep. 25, 2009 (KR) 10-2009-0091146

(51) Int. Cl. G11B 21/02

(52) U.S. Cl. 360/75; G9B/21.003

(57) ABSTRACT

A disk drive comprises a disk, and a head for reading and writing data on the disk. The disk drive detects head-disk interference (HDI) during a write operation by measuring a parameter during the write operation and comparing the measured parameter against a reference parameter. The reference parameter is measured while the disk drive generates HDI under a set of reference conditions. In various embodiments, the reference parameter comprises attributes of a position error signal, a servo automatic gain control, a jitter representing a difference between a current velocity and a target velocity of a spindle motor, and a bias applied to a voice coil motor.

### CROSS-REFERENCE TO RELATED APPLICATIONS

This application claims priority under 35 U.S.C. §119 to Korean Patent Application No. 10-2009-0091146 filed on Sep. 25, 2009, the disclosure of which is hereby incorporated by reference in its entirety.

### BACKGROUND

Embodiments of the inventive concept relate generally to disk drives. More particularly, embodiments of the inventive concept relate to disk drives that operate to detect head-disk interference by comparing one or more parameters measured during a write operation with one or more reference parameters measured while head-disk interference is generated under reference conditions.

A hard disk drive uses a magnetic head to perform read and write operations on a disk. During the read and write operations, the head is maintained at a distance from the disk while the disk spins. Where the head is not properly aligned with data storage tracks of the disk, or where the head is not located at a proper distance from the disk, head-disk interference can occur.

Head-disk interference can cause various defects in the disk and can prevent writing operations from being performed properly. Accordingly, it is desirable to both detect and prevent head-disk interference.

### SUMMARY

Embodiments of the inventive concept provide disk drives and methods of controlling the disk drives. In certain embodiments, the disk drives are controlled to determine head-disk interference.

According to one embodiment of the inventive concept, a method of controlling a disk drive comprises determining a reference frequency and a reference amplitude from a first position error signal of a head of the disk drive, determining a frequency and an amplitude from a second position error signal generated during a writing operation of the disk drive, comparing the determined frequency with the reference frequency, and comparing the determined amplitude with the reference amplitude, and determining the occurrence of head-disk interference in the disk drive based on the comparisons.

In certain embodiments, determining the reference frequency and the reference amplitude comprises measuring the first position error signal while generating head-disk interference on a normal track of the disk drive, and performing a fast Fourier transform on the first position error signal and selecting the reference frequency and the reference amplitude from the fast Fourier transform.

In certain embodiments, measuring the first position error signal comprises iteratively writing predetermined data in the normal track and then decreasing a flying height of the head until HDI occurs, and measuring the first position error signal after the head-disk interference occurs.

In certain embodiments, determining the reference frequency and the reference amplitude comprises determining reference frequencies and reference amplitudes for a plurality of heads of the disk drive as references for determining the occurrence of HDI between each of the plurality of heads and a corresponding disk.

In certain embodiments, determining the frequency and the amplitude comprises counting a number of times a write retry operation is performed during the writing operation, comparing the number of write retry operations with a predetermined critical value, and where the counted number of write retry operations is greater than the predetermined critical value, performing a fast Fourier transform on the second PES, and selecting the frequency and the amplitude from the fast Fourier transform.

In certain embodiments, determining the occurrence of head-disk interference comprises determining a difference between the frequency and the reference frequency, determining a difference between the amplitude and the reference amplitude, and determining that head-disk interference occurs where the difference between the frequency and the reference frequency is less than or equal to a predetermined value and the difference between the amplitude and the reference amplitude is greater than the reference amplitude.

In certain embodiments, the method further comprises upon determining that HDI occurs, increasing a flying height of the head and then performing another writing operation, and determining whether data is successfully written to the disk drive in the another writing operation.

In certain embodiments, the method further comprises determining a reference value of a predetermined parameter as a reference for determining the occurrence of head-disk interference, measuring a value of the parameter during a writing operation, and comparing the measured value of the parameter with the reference value.

In certain embodiments, the parameter comprises at least one of a servo automatic gain control, a jitter representing a difference between a current velocity and a target velocity of a spindle motor of the disk drive, and a bias applied to a voice coil motor of the disk drive.

In certain embodiments, the occurrence of head-disk interference is determined based on at least one of a comparison result relating to the second position error signal, a comparison result relating to the servo automatic gain control, a comparison result relating to the jitter, and a comparison result relating to the bias.

According to another embodiment of the inventive concept, a method of controlling a disk drive comprises determining a reference value of a predetermined parameter of the disk drive, measuring a value of the parameter during a writing operation of the disk drive, comparing the measured value of the parameter with the reference value, and determining the occurrence of head-disk interference based on a result of the comparison.

In certain embodiments, the parameter comprises at least one of a servo automatic gain control, a jitter representing a difference between a current velocity and a target velocity of a spindle motor of the disk drive, and a bias applied to a voice coil motor of the disk drive.

In certain embodiments, the occurrence of head-disk interference is determined based on at least one of a comparison result related to a position error signal of the disk drive, a comparison result related to the servo automatic gain control, a comparison result relating to the jitter, and a comparison result related to the bias.

In certain embodiments, determining the reference value comprises iteratively writing predetermined data in a track of the disk drive and then decreasing a flying height of a head of the disk drive until head-disk interference occurs, and determining the reference value by measuring a value of the parameter during occurrence of the head-disk interference.

According to another embodiment of the inventive concept, a disk drive comprises a disk, a head for writing data to the disk, and a controller for controlling the head. The controller comprises a determination unit that determines a reference frequency and a reference amplitude from a first position error signal and determines a frequency and an amplitude from a second position error signal generated during a writing operation, a comparison unit that compares the frequency with the reference frequency and outputs a comparison signal indicating a result of the comparison, and a control signal generating unit that generates a control signal based on the comparison signal, and the control signal is used to control the head.

In certain embodiments, the first position error signal is measured while head-disk interference is generated on a normal track of the disk drive. Additionally, the determination unit determines the reference frequency and the reference amplitude by performing a fast Fourier transform on the first position error signal, and the determination unit determines the frequency and the amplitude by performing a fast Fourier transform on the second position error signal.

In certain embodiments, the control signal generating unit generates the control signal to increase a flying height of the head upon determining that a difference between the frequency and the reference frequency is less than or equal to a predetermined value and the amplitude is greater than the reference amplitude.

In certain embodiments, the determination unit determines a reference value related to a predetermined parameter of the disk drive, and measures a value of the predetermined parameter during a writing operation, and the comparison unit compares the measured value of the parameter with the reference value and outputs a comparison signal based on the comparison.

In certain embodiments, the disk drive further comprises a spindle motor for rotating the disk at a predetermined speed, and a voice coil motor for driving the head. The parameter comprises at least one of a servo automatic gain control, a jitter representing a difference between a current velocity and a target velocity of the spindle motor, and a bias applied to the voice coil motor.

In certain embodiments, the control signal generating unit generates the control signal using at least one of a comparison result related to the second PES, a comparison result related to the servo automatic gain control, a comparison result related to the jitter, and a comparison result related to the bias.

### BRIEF DESCRIPTION OF THE DRAWINGS

The attached drawings illustrate various embodiments of the inventive concept. In the drawings like reference numerals denote like features.

FIG. 1 is a schematic diagram of a head disk assembly of a disk drive according to an embodiment of the inventive concept.

FIG. 2 is a block diagram illustrating electrical connections of the disk drive according to an embodiment of the inventive concept.

FIG. 3A is a flowchart illustrating a method of controlling a disk drive according to an embodiment of the inventive concept.

FIG. 3B is a flowchart illustrating a method of determining a reference frequency and amplitude in the method of FIG. 3A according to an embodiment of the inventive concept.

FIG. 4A is a graph illustrating a waveform of a position error signal where head-disk interference occurs.

FIG. 4B is a graph illustrating a waveform obtained by transforming the position error signal of FIG. 4A using a fast Fourier transform.

FIG. 5A is a flowchart illustrating a method of controlling a disk drive according to another embodiment of the inventive concept.

FIG. 5B is a flowchart illustrating a method of determining a reference value for a predetermined parameter in the method of FIG. 5A according to an embodiment of the inventive concept.

FIG. 6 is a flowchart illustrating an example of the method of FIG. 5 where the predetermined parameter is a servo automatic gain control.

FIG. 7A is a graph illustrating a servo automatic gain control value and a reference value.

FIG. 7B is a graph illustrating a servo automatic gain control value measured in the method of FIG. 6.

FIG. 8 is a flowchart illustrating an example of the method of FIG. 5 where the predetermined parameter is a jitter.

FIG. 9A is a graph illustrating a jitter value of a disk drive in a normal state.

FIG. 9B is a graph illustrating a jitter value and a reference value of a disk drive having head-disk interference.

FIG. 9C is a graph illustrating a jitter value measured in the method of FIG. 8.

FIG. 10 is a flowchart illustrating an example of the method of FIG. 5 where the parameter is a bias.

FIG. 11A is a graph illustrating a bias value of a disk drive in a normal state.

FIG. 11B is a graph illustrating a bias value and a reference value of a disk drive having head disk interference.

FIG. 11C is a graph illustrating a bias value measured in the method of FIG. 10.

FIG. 12 is a flowchart illustrating a method of controlling a disk drive according to another embodiment of the inventive concept.

FIG. 13 is a block diagram illustrating a controller of FIG. 2 according to an embodiment of the inventive concept.

### DETAILED DESCRIPTION OF THE EMBODIMENTS

Selected embodiments of the inventive concept are described below with reference to the accompanying drawings. These embodiments are presented as teaching examples and should not be interpreted to limit the scope of the inventive concept.

In general, the described embodiments relate to a disk drive comprising a head disk assembly (HDA).

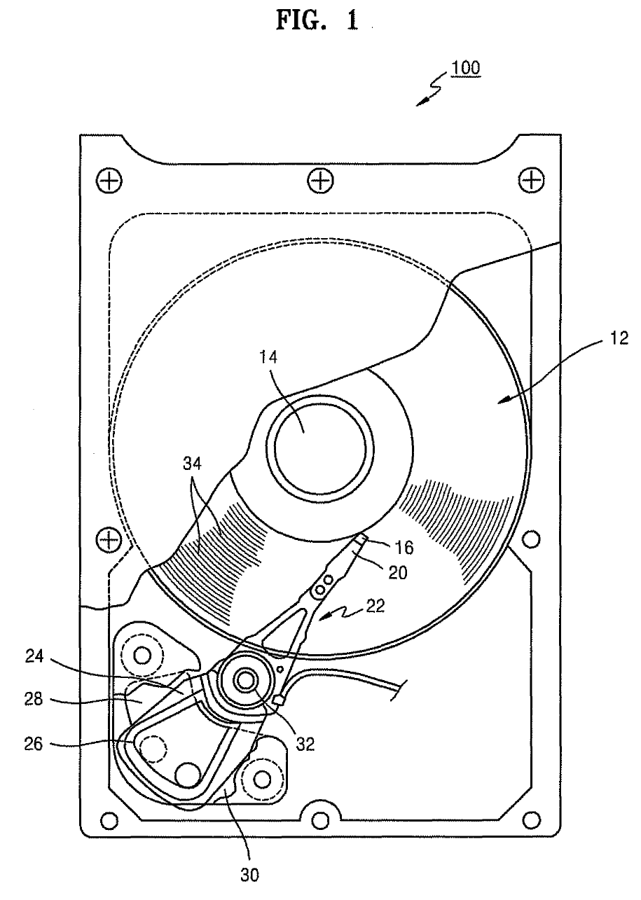

FIG. 1 is a schematic diagram of a HDA 100 of a disk drive according to one embodiment of the inventive concept.

Referring to FIG. 1, HDA 100 comprises at least one magnetic disk 12 that is rotated by a spindle motor 14. HDA 100 further comprises a head 16 located adjacent to a surface of disk 12.

Head 16 comprises one or more transducers that sense a magnetic field of disk 12 or magnetize disk 12 to read or write information from or to disk 12 as it is rotated. For instance, head 16 can comprise a write transducer for magnetizing disk 12 and a read transducer for magnetizing disk 12. The read transducer typically comprises a magneto-resistive (MR) device.

Head 16 is integrated with a slider 20, and slider 20 is coupled to a head stack assembly 22. Head stack assembly 22 is attached to an actuator arm 24 having a voice coil 26. Voice coil 26 is disposed adjacent to a magnetic assembly 28 to form a voice coil motor (VCM) 30. A current supplied to voice coil 26 generates torque for rotating actuator arm 24 with respect to bearing assembly 32. Due to the rotation of actuator arm 24, transducer 16 is moved across the surface of disk 12.

Data is stored in a plurality of ring-shaped tracks 34 of disk 12. Where multiple disks are stacked on top of each other, cylinders are formed by corresponding tracks on different disks. Each of tracks 34 typically comprises a plurality of sectors. Each sector comprises a data field and a servo field. The servo field stores a preamble, a servo address/index mark (SAM/SIM), a gray code, and a burst signal. The transducer moves across the surface of disk 12 to read or write information on different tracks.

Head 16 comprises a structure for forming an air bearing between the surface of disk 12 and the transducers, and a heater (not shown) for heating the structure that forms the air bearing.

In some embodiments, HDA 100 comprises a plurality of disks 12 and a plurality of heads 16 corresponding to the surfaces of the plurality of disks 12. For example, where HDA 100 comprises two disks 12, HSA 22 can comprise four heads 16 and corresponding heaters.

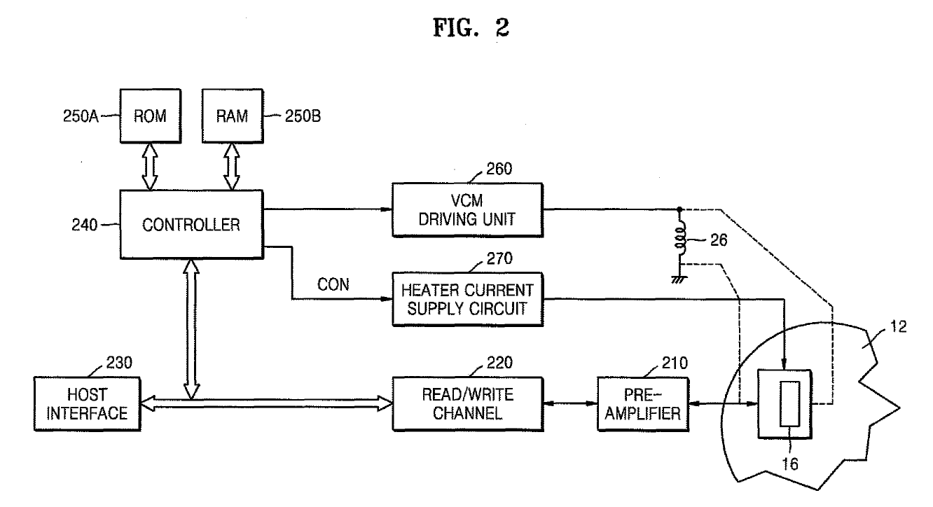

FIG. 2 is a diagram illustrating electrical connections of the disk drive of FIG. 1, according to an embodiment of the inventive concept.

Referring to FIG. 2, the disk drive comprises disk 12, head 16, a pre-amplifier 210, a read/write channel 220, a host interface 230, a controller 240, a read only memory (ROM) 250A, a random access memory (RAM) 250B, a VCM driving unit 260, and a heater current supply circuit 270.

ROM 250A stores firmware and control information for controlling the disk drive. During initialization of the disk drive, information for controlling the disk drive is read from ROM 250A or disk 12 and stored in RAM 250B.

Controller 240 analyzes instructions received from a host device (not shown) through host interface 230 and performs control operations based on the analysis. Controller 240 sends control signals to VCM driving unit 260 and heater current supply circuit 270 to control the movement of head 16.

In a read operation of the disk drive, pre-amplifier 210 amplifies an electrical signal detected from disk 12 by the read transducer. Next, the amplified signal is gain-controlled by a gain control circuit (not shown) of read/write channel 220 to amplify the signal to a predetermined level. Then, the signal amplified by the gain control circuit is encoded into a digital signal readable by the host device, and the digital signal is converted into stream data and sent to the host device through host interface 230.

In a write operation of the disk drive, data received from the host device through host interface 230 is converted into a binary data stream suitable for a write channel by read/write channel 220. Then, pre-amplifier 210 amplifies a write current and the write transducer of head 16 writes the binary data stream on disk 12 using the amplified write current. In the write operation, read/write channel 220 provides information to controller 240 for controlling track-seek and track-following operations while reproducing the preamble, SAM/SIM, gray code, and burst signals.

In a servo copy process, read/write channel 220 provides information to controller 240 for controlling track-seek and track-following operations while reproducing a reference servo pattern recorded on a surface of disk 12 or a plurality of disks 12 using a reference head.

Controller 240 generally receives at least one parameter value to generate a control signal CON for controlling head 16. Control signal CON comprises a flying on demand (FOD) signal for determining a current to be applied to the heater of head 16. Heater current supply circuit 270 determines the current to be applied to the heater of head 16 in response to control signal CON. Thermal expansion of a pole tip of head 16 varies according to the magnitude of the current applied to the heater of head 16, and therefore controller 240 controls the flying height of head 16 by controlling the current supplied to the heater of head 16. The parameter value received by controller 240 typically comprises at least one of a servo automatic gain control value, a jitter value representing a difference between the current velocity of spindle motor 14 and a target velocity, and a bias value applied to voice coil motor VCM 30.

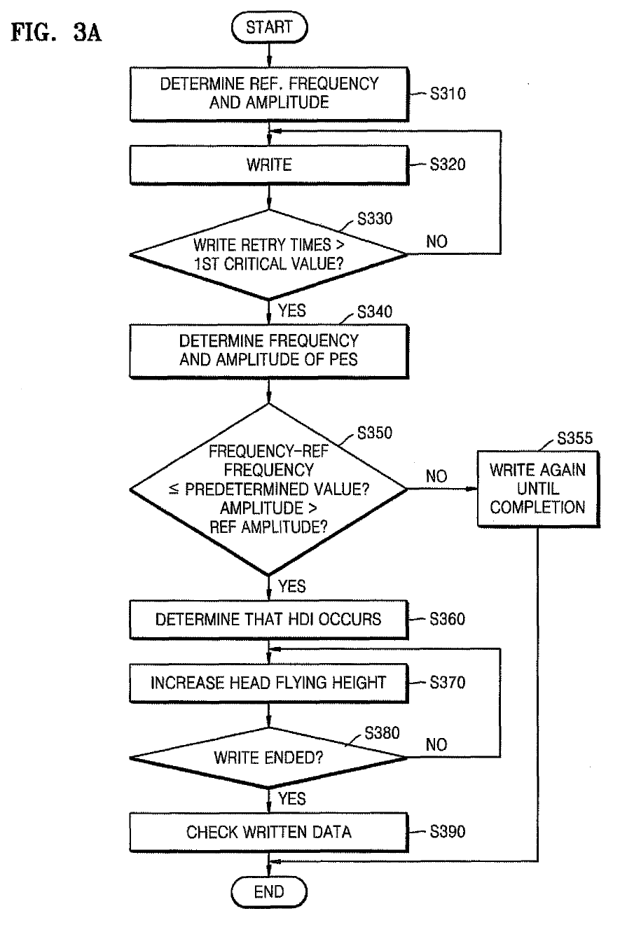

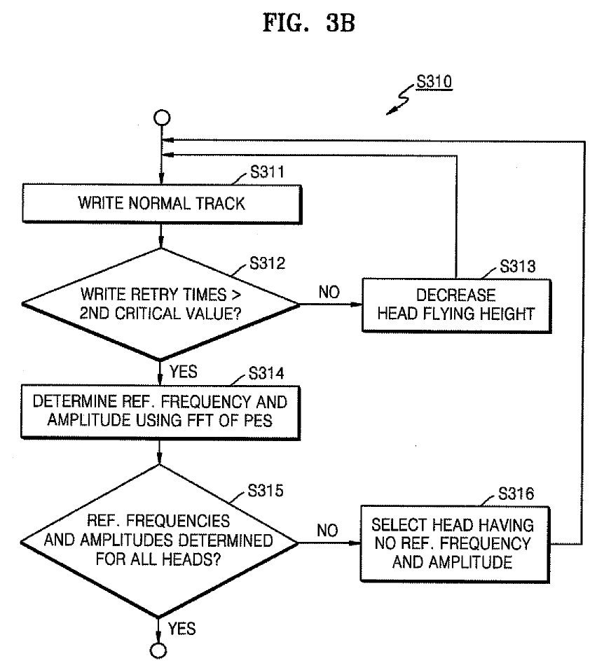

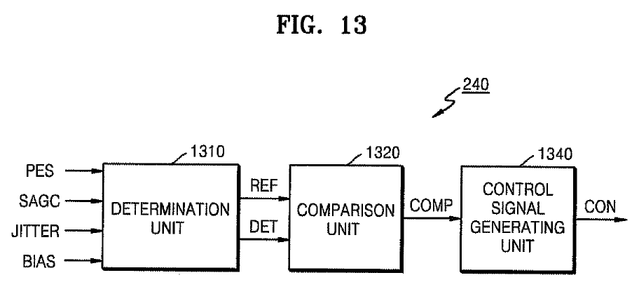

The operation of controller 240 is described in further detail with reference to FIGS. 3A through 12, and the structure of controller 240 is described in further detail with reference to FIG. 13.

FIG. 3A is a flowchart illustrating a method of controlling a disk drive according to an embodiment of the inventive concept. In the description that follows, example method steps or operations are denoted by parentheses (SXXX).

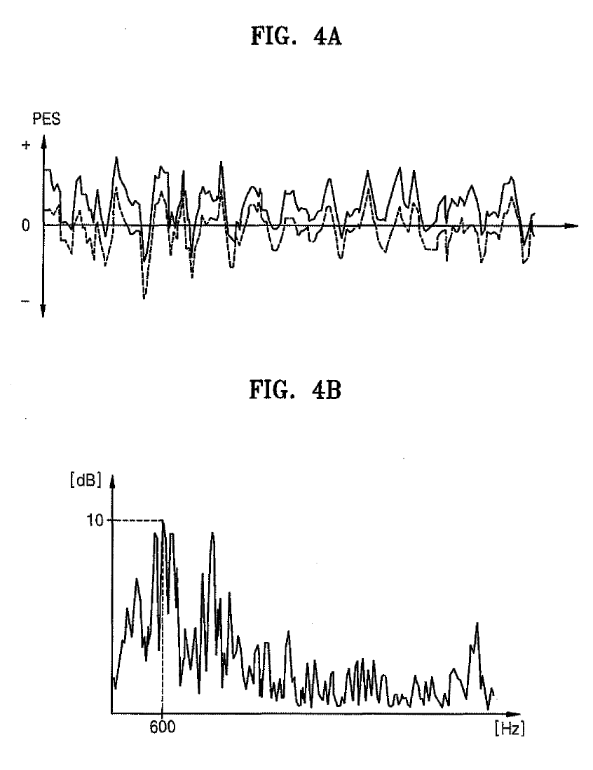

Referring to FIGS. 1 through 3A, controller 240 determines a reference frequency and a reference amplitude that are related to a position error signal (PES), as reference values for detecting head-disk interference (HDI) (S310). In one example, controller 240 determines the reference frequency and amplitude by detecting a PES generated by head 16 when induced to generate HDI on a normal track under controlled conditions, such as those described below with reference to FIG. 3B. The generated PES is then transformed into the frequency domain using a fast Fourier transform (FFT), and a maximum amplitude of the FFT is used as the reference amplitude while the frequency corresponding to the maximum amplitude is used as the reference frequency. In addition, controller 240 determines reference frequencies and reference amplitudes for all heads 16 and stores them in a table. A further explanation of operation 310 is provided below with reference to FIGS. 3B and 4B.

After the reference frequency and the reference amplitude are determined, head 16 attempts to write data to disk 12 (S320). Where a write error occurs in operation S320, writing is retried in a write retry operation. Controller 240 counts the number of times the write retry operation is performed and compares the number of write retry operations with a first critical value (S330). The first critical value can be determined according to various properties of the disk drive. Where the number of write retry operations is less than or equal to the first critical value, the method returns to operation S320 so that head 16 attempts another writing operation. Otherwise, where the number of write retry operations is greater than the first critical value, controller 240 measures a PES from the head 16 that is performing a current writing operation and determines a frequency and an amplitude of the PES (S340). For example, in operation S340, controller 240 can measure a PES from head 16 that is currently performing a writing operation, and determine a frequency and an amplitude using values obtained by transforming the PES using the FFT. In one example, the amplitude is the maximum of the values obtained by the FFT, and the frequency is a frequency corresponding to the maximum.

Controller 240 compares the frequency determined in operation S340 with the reference frequency determined in operation S310, and the amplitude determined in operation S340 with the reference amplitude determined in operation S310 (S350). For example, where there are 1st through n-th heads (n is a natural number) and a frequency and an amplitude are determined for a k-th head in operation S340 (1≦k≦n), controller 240 compares the frequency and amplitude of the k-th head, which are determined in operation S340, with a reference frequency and a reference amplitude of the k-th head, which are determined in operation S310.

Where the difference between the frequency determined in operation S340 and the reference frequency determined in operation S310 is greater than a predetermined value but the amplitude determined in operation S340 is less than or equal to the reference amplitude determined in operation S310 (S350=No), the method determines that there is no HDI, and writing is retried until the data is written without an error (S355). On the other hand, where the difference between the frequency determined in operation S340 and the reference frequency determined in operation S310 is less than or equal to the predetermined value but the amplitude determined in operation S340 is greater than the reference amplitude determined in operation S310 (S350=Yes), it is determined that there is HDI (S360). For example, suppose the reference frequency is 300 Hz, the reference amplitude is 10 dB, and the predetermined value is 50 Hz. Where the frequency and amplitude determined in operation S340 respectively are 100 Hz and 8 dB, it is determined that there is no HDI, and operation S355 is performed. As an alternative example, where the frequency and amplitude determined in operation S340 are respectively 330 Hz and 12 dB, it is determined that there is HDI in operation S360.

Where it is determined that there is HDI in operation S360, controller 240 increases the flying height of the head 16 that is performing a current writing operation (S370). For example, controller 240 can output a control signal CON to heater current supply circuit 270 as an FOD signal, and heater current supply circuit 270 can adjust a current supplied to head 16 in response to control signal CON to control the flying height of head 16.

After the flying height of head 16 is controlled, another writing operation is performed, and then it is determined whether the writing operation has been completed (S380). Where the writing operation has not been completed (S380=No), the method returns to operation S370 to increase the flying height of head 16 and retry the writing operation. In other words, until the writing operation is completed, the flying height of head 16 is increased and the writing operation is repeated. On the other hand, where it is determined that the writing operation has been completed (S380=Yes), the method checks whether the data is normally written (S390). In other words, operation S390 checks for errors such as those caused by HDI or by an increase of the flying height of head 16.

FIG. 3B is a flowchart illustrating an embodiment of operation S310 of FIG. 3A.

Referring to FIGS. 1 through 3B, controller 240 controls head 16 to write data to a track having a good PES, i.e., a normal track (S311). Where an error occurs in operation S311, the writing operation is performed again in a write retry operation. Controller 240 counts the number of times the write retry operation is performed and compares the number of write retry operations with a second critical value (S312). The second critical value can be determined based on various properties of the disk drive.

Where the number of write retry operations is not greater than the second critical value (S312=No), the flying height of head 16 is decreased (S313), and operation S311 is repeated. In other words, operations S312 and S313 are performed to generate HDI intentionally at the normal track. Where the flying height of head 16 is sufficiently decreased and the number of write retry operations becomes greater than the second critical value (S312=Yes), controller 240 determines that there is HDI and measures a PES. Then, based on the measured PES, controller 240 determines a reference frequency and a reference amplitude (S314). For example, controller 240 can determine the reference frequency and the reference amplitude using values obtained from an FFT of the PES. The determination of the reference frequency and the reference amplitude from the FFT will be described in further detail with reference to FIGS. 4A and 4B.

After the reference frequency and the reference amplitude are determined in operation S314, the method determines whether reference frequencies and reference amplitudes have been determined for all heads (S315). Where there is a head for which a reference frequency and a reference amplitude are not determined (S315=No), operations 311 through 314 are performed for the head. For example, where there are 1st through n-th heads, reference frequencies and reference amplitudes are determined for the 1st through n-th heads. The reference frequencies and amplitudes can then be stored in a table.

FIG. 4A is a graph illustrating a waveform of a PES when HDI occurs in the disk drive.

Referring to FIG. 4A, the PES fluctuates between positive (+) and negative (−) values about a zero line “0”. As the PES approaches the zero line, a head gets closer to the center of a track, and as the PES gets farther from the zero line, the head distances from the center of the track. Referring to FIG. 4A, due to HDI, the PES is often removed from the zero line.

FIG. 4B is a graph illustrating a waveform obtained by transforming the PES of FIG. 4A using a FFT.

Referring to FIGS. 4A and 4B, the PES of FIG. 4A is transformed by the FFT and shown in the frequency domain in FIG. 4B. The maximum amplitude of the transformed PES is 10 dB, which occurs at a frequency of 600 Hz.

In the following description, it is assumed that the PES of FIG. 4A is measured upon determining in operation S312 that the number of write retry operations is greater than the second critical value. A reference frequency and a reference amplitude are determined in operation S314 using the graph of FIG. 4B. For example, in FIG. 4B, the maximum amplitude of the PES transformed by the FFT is 10 dB, and a frequency corresponding to the maximum is 600 Hz. In this case, 600 Hz is determined as the reference frequency, and 10 dB is determined as the reference amplitude. Alternatively, a value smaller than the maximum amplitude can be determined as the reference amplitude.

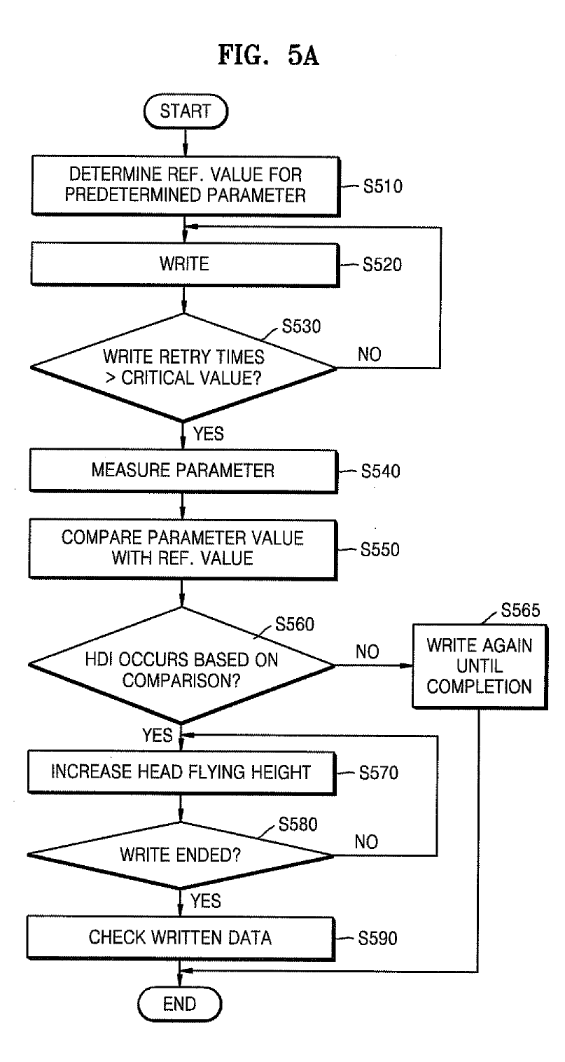

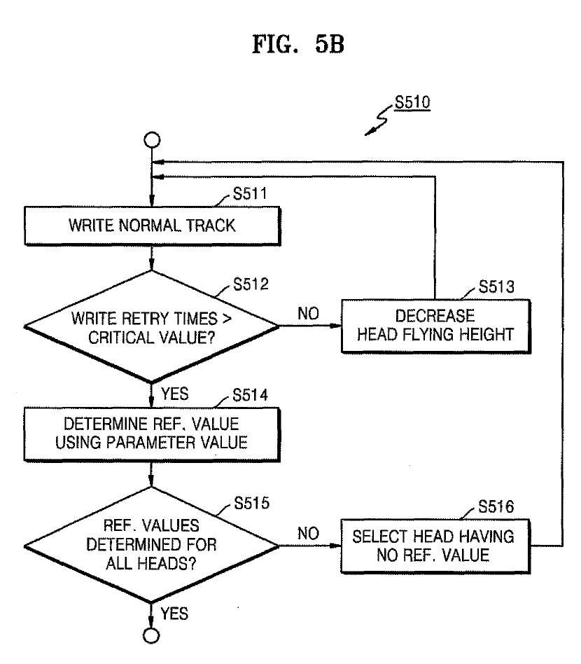

FIG. 5A is a flowchart illustrating a method of controlling a disk drive according to another embodiment of the inventive concept.

Referring to FIGS. 1, 2, and 5A, controller 240 determines a reference value related to a predetermined parameter, as a reference for determining the occurrence of HDI (S510). The parameter typically comprises at least one of a servo automatic gain control, a jitter, and, and a bias. The servo automatic gain control is a parameter used to control a signal amplified by pre-amplifier 210 at a predetermined level. The jitter represents a difference between the current velocity of spindle motor 14 and a target velocity, and the bias is a voltage applied to voice coil motor VCM 30. Controller 240 determines reference values for all heads 16 and stores the reference values in a predetermined table according to the different heads 16. Operation S510 for determining the reference value is described in further detail below with reference to FIG. 5B.

After the reference value is determined, head 16 attempts to write data to disk 12 (S520). Where a write error occurs in operation S520, writing is retried in a write retry operation. Controller 240 counts the number of times the write retry operation is performed and compares the number of write retry operations with a predetermined critical value (S530). The critical value can vary according to the type of the parameter. Where the number of write retry operations is not greater than the critical value (S530=No), the method returns to operation S520 so that head 16 attempts a writing operation again. Otherwise, where the number of write retry operations is greater than the critical value (S530=Yes), controller 240 measures a parameter relating to the current writing operation (S540).

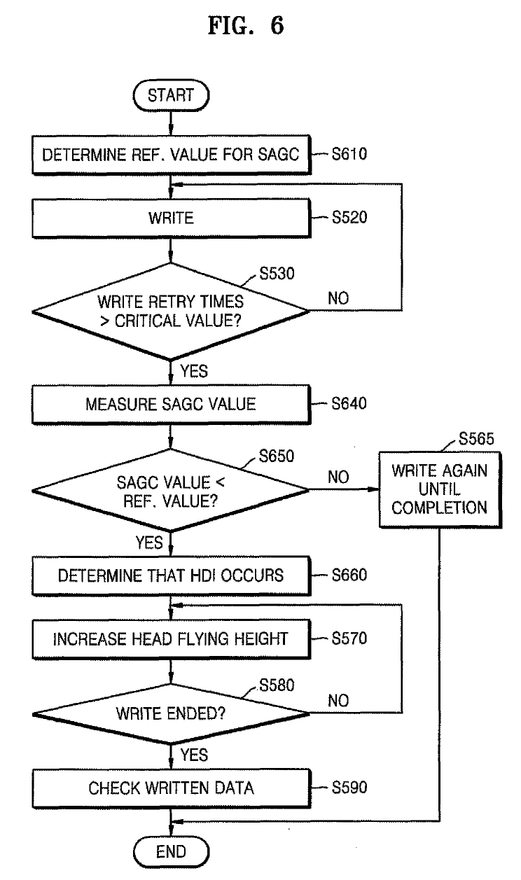

Controller 240 compares the parameter value measured in operation S540 with the reference value determined in operation S510 (S550). For example, where there are 1st through n-th heads and a parameter of a k-th head (1≦k≦n) is measured in operation S540, controller 240 compares the parameter value of the k-th head, which is measured in operation S540, with a reference value of the k-th head, which is determined in operation S510. A method of determining the occurrence of HDI according to the relationship between the parameter value measured in operation S540 and the reference value determined in operation S510 will be explained for various parameters with reference to FIGS. 6 through 11.

The method next determines whether HDI has occurred based on the comparison result obtained in operation S550 (S560). Where it is determined that there is no HDI (S560=No), writing is retried until the data is written without an error (S565). Otherwise, where it is determined that there is HDI (S560=Yes), controller 240 increases the flying height of the head 16 that is performing a current writing operation (S570). For example, controller 240 can output a control signal CON to heater current supply circuit 270 as an FOD signal, and heater current supply circuit 270 can adjust a current supplied to head 16 in response to control signal CON to control the flying height of head 16.

After the flying height of head 16 is controlled, a writing operation is repeated, and the method determines whether the writing operation has been completed (S580). Where the writing operation has not been completed (S580=No), the method returns to operation S570 to increase the flying height of head 16 and retry the writing operation. In other words, until the writing operation has been completed, the flying height of head 16 is incrementally increased, and the writing operation is repeated. Otherwise, where it is determined that the writing operation has been completed (S580=Yes), the method checks whether the data is normally written (S590). In other words, operation S590 can be optionally performed to check an error such as an error caused by HDI or an error caused by an increase of the flying height of head 16.

FIG. 5B is a flowchart illustrating an example of operation S510 of FIG. 5A.

Referring to FIGS. 1, 2, 5A, and 5B, controller 240 finds a normal track and controls head 16 so that head 16 writes data on the normal track (S511). Where an error occurs in the writing operation of operation S511, the writing operation is repeated in a write retry operation. Controller 240 counts the number of times the write retry operation is performed and compares the number of write retry operations with a predetermined critical value (S512). The critical value can vary according to the type of the parameter. Moreover, the critical value can be equal to or different from the critical value of operation S530.

Where the number of write retry operations is not greater than the critical value (S512=No), the flying height of head 16 is decreased (S513), and operation S511 is repeated. That is, operations S512 and S513 are performed to generate HDI intentionally at the normal track. Where the flying height of head 16 is sufficiently decreased and the number of write retry operations becomes greater than the critical value (S512=Yes), controller 240 determines that there is HDI and measures a parameter. Then, by using the measured parameter, controller 240 determines a reference value (S514). Methods of determining reference values according to parameters will be described in further detail with reference to FIGS. 6 through 11.

After the reference value is determined in operation S514, the method determines whether reference values have been determined for all heads (S515). Where there is a head for which a reference value has not determined, operations 511 through 514 are performed for the head. For example, where there are 1st through n-th heads, reference values are determined for the 1st through n-th heads, and the reference values are stored in a table.

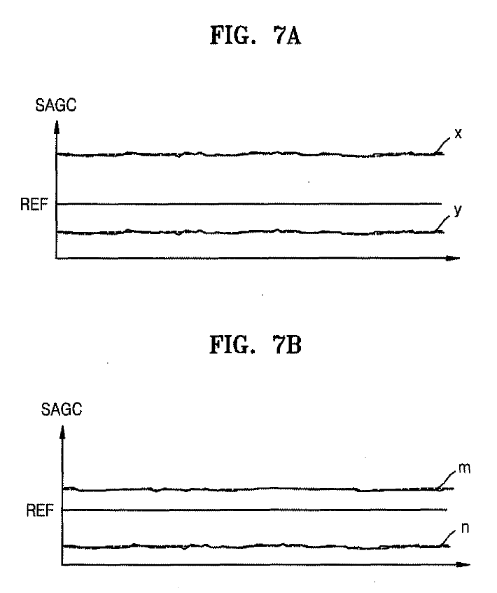

FIG. 6 is a flowchart illustrating an example of the method of FIG. 5 where the predetermined parameter is servo automatic gain control. FIG. 7A is a graph illustrating a servo automatic gain control value and a reference value, and FIG. 7B is a graph illustrating a servo automatic gain control value measured in operation S640 of FIG. 6.

Referring to FIGS. 1, 2, and 5A through 7B, controller 240 determines a reference value relating to servo automatic gain control as a reference for determining the occurrence of HDI (S610). Operation S610 comprises the operations described with reference to FIG. 5B. A servo automatic gain control value decreases as the distance between head 16 and disk 12 decreases and increases as the distance between head 16 and disk 12 increases. Therefore, in a normal state, a servo automatic gain control value corresponding to a curve “x” is detected. Where HDI occurs, a relatively smaller servo automatic gain control value corresponding to a curve “y” is detected. In operation S514 of FIG. 5B, a value greater than or equal to the average amplitude of a servo automatic gain control signal corresponding to curve “y” of FIG. 7A is determined as a reference value relating to servo automatic gain control.

After the reference value is determined in operation S610, the same operations S520 and S530 explained with reference to FIG. 5A are performed. Because operations S520 and 530 are described above, further descriptions of these operations will be omitted to avoid redundancy. In operation S530, where the number of write retry operations is greater than a critical value, controller 240 measures a servo automatic gain control value relating to the current writing operation (S640).

Next, controller 240 compares the servo automatic gain control value measured in operation S640 with the reference value determined in operation S610 (S650). Where the servo automatic gain control value measured in operation S640 is greater than or equal to the reference value determined in operation S610, as shown by a curve “m” in FIG. 7B (S650=No), operation S565 is performed. Otherwise where the servo automatic gain control value measured in operation S640 is smaller than the reference value determined in operation S610 (S650=Yes), as shown by a curve “n” in FIG. 7B, it is determined that there is HDI (S660), and operations S570 through S590 explained with reference to FIG. 5A are performed. Since operations 565 through 590 have been described in detail with reference to FIG. 5A, further descriptions of these operations will be omitted to avoid redundancy.

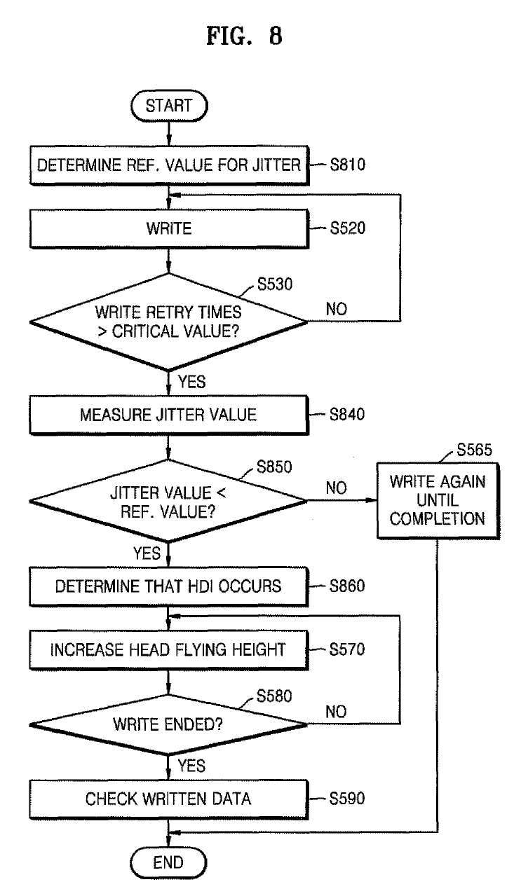

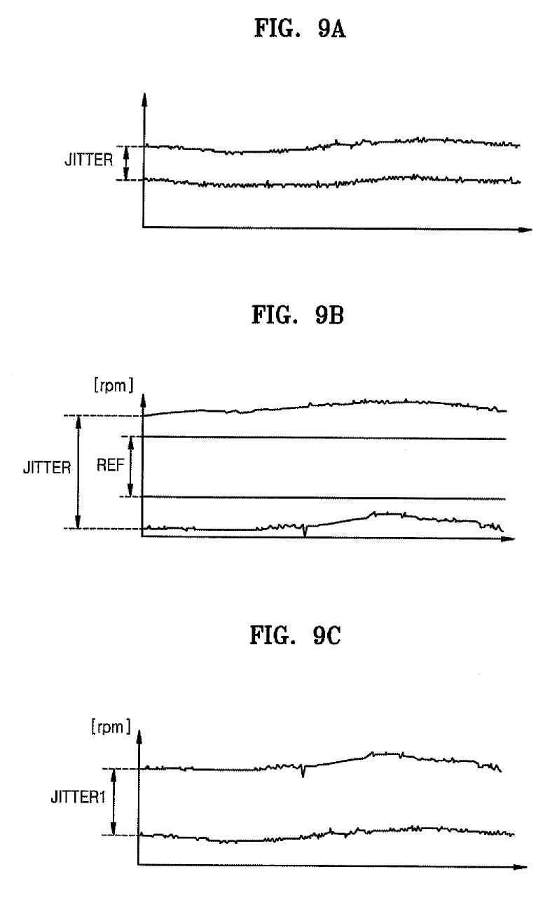

FIG. 8 is a flowchart illustrating an example of the method of FIG. 5 where the predetermined parameter is jitter. FIG. 9A is a graph illustrating a jitter value of a disk drive in a normal state. FIG. 9B is a graph illustrating a jitter value and a reference value of a disk drive having HDI. FIG. 9C is a graph illustrating a jitter value measured in operation S840 of FIG. 8.

Referring to FIGS. 1, 2, 5A, 5B, and 8 through 9C, controller 240 determines a reference value relating to jitter as a reference for determining the occurrence of HDI (S810). Operation S810 comprises the operations described with reference to FIG. 5B. A jitter value is relatively low where there is no HDI but relatively high where there is HDI. For instance, the jitter value is relatively low in a normal state shown in FIG. 9A but relatively high in an example having HDI as shown in FIG. 9B. In operation S514, a value less than or equal to the average of the jitter value shown in FIG. 9B is determined as a reference value relating to jitter.

After the reference value is determined in operation S810, operations S520 and S530 explained with reference to FIG. 5A are performed. Because these operations are described above, further descriptions thereof will be omitted to avoid redundancy. In operation S530, where the number of write retry operations is greater than a critical value, controller 240 measures a jitter value relating to the current writing operation (S840). Controller 240 compares the jitter value measured in operation S840 with the reference value determined in operation S810 (S850).

For explanation purposes, it will be assumed that the jitter value measured in operation S840 has a jitter range value JITTER1 shown in FIG. 9C. Where jitter range value JITTER1 is less than or equal to the reference value determined in operation S810 (S850=No), operation S565 is performed. Otherwise, where the jitter range value JITTER1 measured in operation S840 is greater than the reference value determined in operation S810 (S850=Yes), it is determined that there is HDI (S860), and the same operations S570 through S590 explained with reference to FIG. 5A are performed. Since operations 565 through 590 have been described in detail with reference to FIG. 5A, further descriptions will be omitted to avoid redundancy.

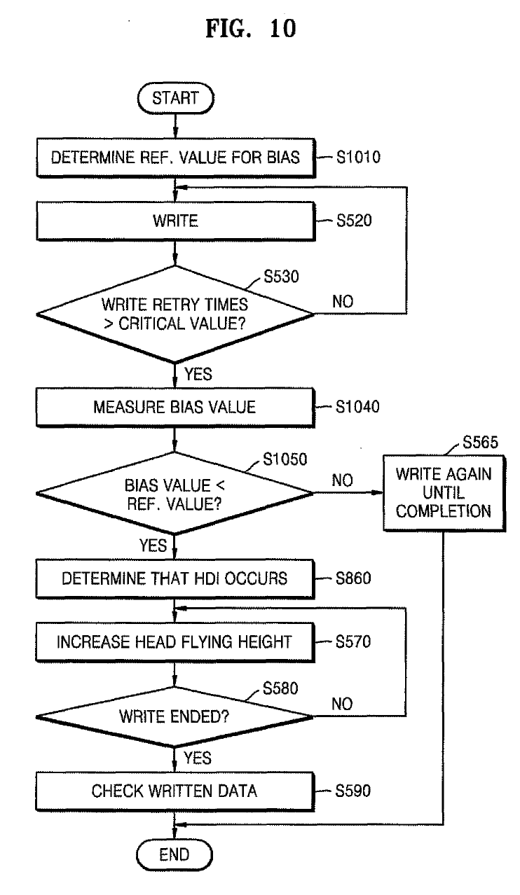

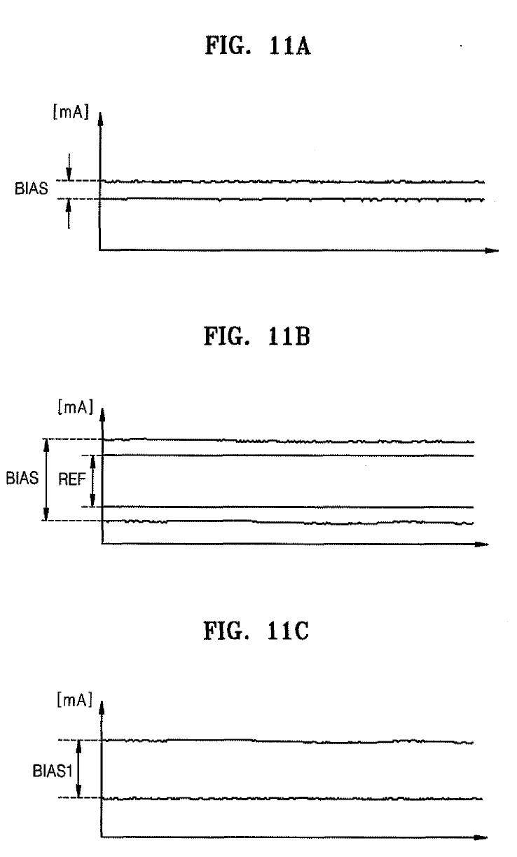

FIG. 10 is a flowchart illustrating an example of the method of FIG. 5 where the predetermined parameter is bias. FIG. 11A is a graph illustrating a bias value of a disk drive in a normal state, FIG. 11B is a graph illustrating a bias value and a reference value in a disk drive having HDI, and FIG. 11C is a graph illustrating a bias value measured in operation S840 of FIG. 10.

Referring to FIGS. 1, 2, 5A, 5B, and 10 through 11C, controller 240 determines a reference value relating to a bias, as a reference for determining the occurrence of HDI (S1010). Operation S1010 comprises the operations described with reference to FIG. 5B. A bias value is relatively low where there is no HDI but relatively high where there is HDI. That is, the bias value is relatively low in a normal state as shown in FIG. 11A but relatively high where HDI is present, as in the example of FIG. 11B. In operation S514, a value less than or equal to an average of the bias value shown in FIG. 11B is determined as a reference value relating to a bias.

After the reference value is determined in operation S1010, operations S520 and S530 are performed as explained with reference to FIG. 5A, and thus detailed descriptions of these operations will not be repeated. Where operation S530 determines that the number of write retry operations is greater than a critical value (S530=Yes), controller 240 measures a bias value relating to the current writing operation (S1040). Controller 240 compares the bias value measured in operation S1040 with the reference value determined in operation S1010 (S1050). For explanation purposes, it will be assumed that the bias value measured in operation S1040 has a bias range value BIAS1 as shown in FIG. 11C. Where bias range value BIAS1 measured in operation S1040 is less than or equal to the reference value determined in operation S1010 (S1050=No), operation S565 is performed. On the other hand, where bias range value BIAS1 measured in operation S1040 is greater than the reference value determined in operation S1010 (S1050=Yes), it is determined that there is HDI (S860), and operations S570 through S590 explained with reference to FIG. 5A are performed. Since operations 565 to 590 have been described in detail with reference to FIG. 5A, a further description of these operations will be omitted to avoid redundancy.

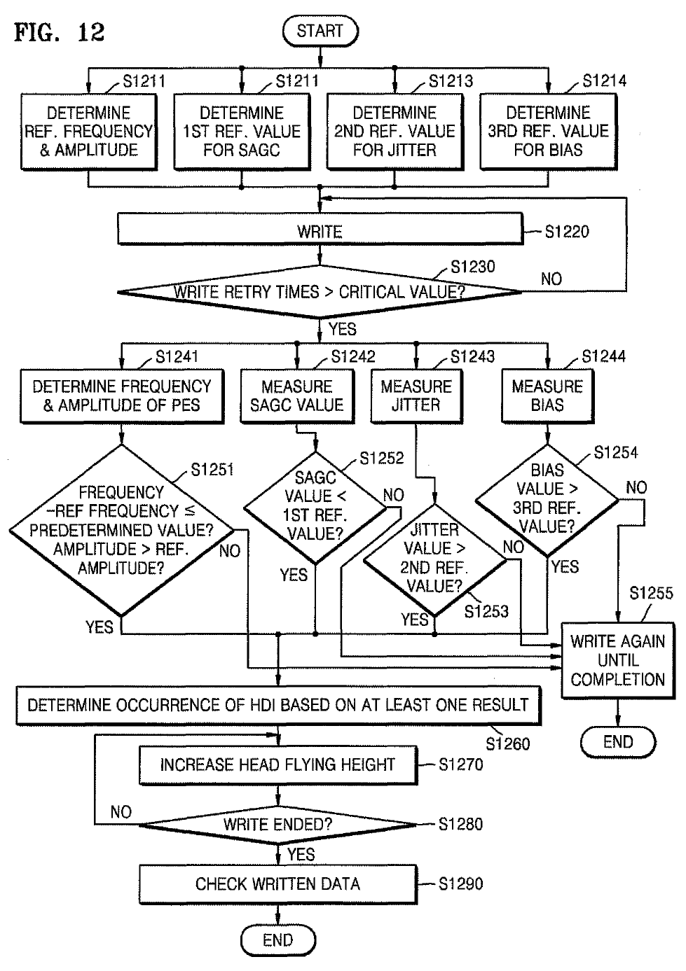

FIG. 12 is a flowchart illustrating a method of controlling a disk drive according to another embodiment of the inventive concept. The method of FIG. 12 combines aspects of the methods described with reference to FIGS. 3A, 5A, 6, 8, and 10. In particular, in the method of FIG. 12, the occurrence of HDI may be determined using at least one of a comparison result relating to a PES, a comparison result relating to a servo automatic gain control, a comparison result relating to a jitter, and a comparison result relating to a bias.

Referring to FIG. 12, controller 240 determines a reference frequency and a reference amplitude that relate to a PES (S1211), and a first reference value relating to servo automatic gain control (S1212). In addition, controller 240 determines a second reference value relating to a jitter (S1213), and a third reference value relating to bias (S1214). Operations 1211 through 1214 can be selectively performed where necessary. Operation S1212 is similar to operation S310 of FIG. 3A, operation S1212 is similar to operation S610 of FIG. 6, operation S1213 is similar to operation S810 of FIG. 8, and operation 1214 is similar to operation S1010. Accordingly, additional detailed descriptions of these operations will be omitted to avoid redundancy.

After operations S1211 through S1214 are performed, head 16 writes data to disk 12 (S1220) and counts the number of times a write retry operation is performed. Controller 240 compares the number of write retry operations with a predetermined critical value (S1230), and repeats operation S1220 upon determining that the number of write retry operations is not greater than the critical value (S1220=No). Operation S1220 is similar to operation S320 of FIG. 3A and operation S520 of FIG. 5A, and operation S1230 is similar to operation S330 of FIG. 3A and operation S530 of FIG. 5A. Accordingly, further description thereof will be omitted to avoid redundancy.

Where the number of write retry operations is greater than the critical value (S1220=Yes), controller 240 measures the frequency and amplitude of a PES (S1241), a servo automatic gain control value (S1242), a jitter value (S1243), and a bias value (S1244) from the head 16 that is performing a current writing operation. Like operations S1211 through S1214, operations S1241 to S1244 can be selectively performed where necessary.

Controller 240 compares the frequency measured in operation S1241 with the reference frequency measured in operation S1211, and the amplitude determined in operation S1241 with the reference amplitude determined in operation S1211 (S1251). In addition, controller 240 compares the servo automatic gain control value measured in operation S1242 with the first reference value determined in operation S1212 (S1252), the jitter value measured in operation S1243 with the second reference value determined in operation S1213 (S1253), and the bias value measured in operation S1244 with the third reference value determined in operation S1214 (S1254). Like operations S1211 through S1214, operations S1251 through S1254 can be selectively performed where necessary.

Operations S1255, S1260, S1270, S1280, and 1290 are performed according to the results of operations S1251 through S1254. Operations S1255, S1260, S1270, S1280, and 1290 are similar to operations S355, S360, S370, S380, and S390 of FIG. 3A, respectively, and therefore further detailed descriptions of these operations will be omitted to avoid redundancy.

In various alternative embodiments, the method of FIG. 12 is performed using only a subset of the illustrated operations. For instance, where occurrence of HDI is determined using only a PES and a jitter, operations S1211 and S1213 are performed but operations S1212 and S1214 are not performed; operations S1241 and S1243 are performed but operations S1242 and S1244 are not performed; and operations S1251 and S1253 are performed but operations S1252 and S1254 are not performed. Furthermore, in the case where occurrence of HDI is determined using a PES and a jitter, operation S1260 can be performed where both or at least one of the conditions of operations S1251 and S1253 is satisfied. Where operation S1260 is performed upon satisfaction of at least one of the conditions of operations S1251 and S1253, operation S1255 is not performed.

FIG. 13 is a block diagram illustrating controller 240 of FIG. 2 according to an embodiment of the inventive concept.

Referring to FIGS. 1 through 13, controller 240 comprises a determination unit 1310, a comparison unit 1320, and a control signal generating unit 1340. According to the various embodiments described with reference to FIGS. 1 through 12, determination unit 1310 can determine a reference frequency and a reference amplitude that relate to a PES as reference values REF for determining the occurrence of HDI, and can determine a frequency and an amplitude DET of a PES generated during a writing operation. Determination unit 1310 can also determine a reference value REF relating to a servo automatic gain control SAGC for determining the occurrence of HDI and may measure a servo automatic gain control value DET during a writing operation. Determination unit 1310 can also determine a reference value REF relating to jitter for determining the occurrence of HDI and can measure a jitter value DET during a writing operation. Determination unit 1310 can also determine a reference value REF relating to a bias for determining the occurrence of HDI and may measure a bias value DET during a writing operation. In other words, determination unit 1310 can perform various operations such as operations S310, S340, S510, and S540.

Comparison unit 1320 can generate a comparison signal COMP by comparing the frequency and amplitude with the reference frequency and amplitude, respectively. In addition, comparison unit 1320 can generate a comparison signal COMP by comparing each of the measured servo automatic gain control value, the jitter value, and the bias value with a corresponding reference value. That is, comparison unit 1320 can perform operations such as operations S350 and S550.

Control signal generating unit 1340 outputs a control signal CON in response to comparison signals COMP to control head 16. In other words, to control head 16, control signal generating unit 1340 generates a control signal CON using at least one of a comparison signal COMP relating to the PES, a comparison signal COMP relating to servo auto gain control SAGC, a comparison signal COMP relating to a jitter, and a comparison signal COMP relating to a bias. As described above, heater current supply circuit 270 applies a predetermined current to head 16 in response to control signal CON to adjust the flying height of head 16.

The foregoing is illustrative of embodiments and is not to be construed as limiting thereof. Although a few embodiments have been described, those skilled in the art will readily appreciate that many modifications are possible in the embodiments without materially departing from the novel teachings and advantages of the inventive concept. Accordingly, all such modifications are intended to be included within the scope of the inventive concept as defined in the claims.

What is claimed is:

1. A method of controlling a disk drive, comprising:
determining a reference frequency and a reference amplitude from a first position error signal (PES) of a head of the disk drive;
determining a frequency and an amplitude from a second PES generated during a writing operation of the disk drive;
comparing the determined frequency with the reference frequency, and comparing the determined amplitude with the reference amplitude; and
determining the occurrence of head-disk interference (HDI) in the disk drive based on the comparisons.

2. The method of claim 1, wherein determining the reference frequency and the reference amplitude comprises:
measuring the first PES while generating HDI on a normal track of the disk drive; and
performing a fast Fourier transform (FFT) on the first PES and selecting the reference frequency and the reference amplitude from the FFT.

3. The method of claim 2, wherein measuring the first PES comprises:
iteratively writing predetermined data in the normal track and then decreasing a flying height of the head until HDI occurs; and
measuring the first PES after the HDI occurs.

4. The method of claim 1, wherein determining the reference frequency and the reference amplitude comprises:
determining reference frequencies and reference amplitudes for a plurality of heads of the disk drive as references for determining the occurrence of HDI between each of the plurality of heads and a corresponding disk.

5. The method of claim 1, wherein determining the frequency and the amplitude comprises:
counting a number of times a write retry operation is performed during the writing operation;
comparing the number of write retry operations with a predetermined critical value; and
where the counted number of write retry operations is greater than the predetermined critical value, performing a fast Fourier transform (FFT) on the second PES, and selecting the frequency and the amplitude from the FFT.

6. The method of claim 1, wherein determining the occurrence of HDI:
determining a difference between the frequency and the reference frequency;
determining a difference between the amplitude and the reference amplitude; and
determining that HDI occurs where the difference between the frequency and the reference frequency is less than or equal to a predetermined value and the difference between the amplitude and the reference amplitude is greater than the reference amplitude.

7. The method of claim 1, further comprising:
upon determining that HDI occurs, increasing a flying height of the head and then performing another writing operation; and
determining whether data is successfully written to the disk drive in the another writing operation.

8. The method of claim 1, further comprising:
determining a reference value of a predetermined parameter as a reference for determining the occurrence of HDI;
measuring a value of the parameter during a writing operation; and
comparing the measured value of the parameter with the reference value.

9. The method of claim 8, wherein the parameter comprises at least one of a servo automatic gain control, a jitter representing a difference between a current velocity and a target velocity of a spindle motor of the disk drive, and a bias applied to a voice coil motor (VCM) of the disk drive.

10. The method of claim 9, wherein the occurrence of HDI is determined based on at least one of a comparison result relating to the second PES, a comparison result relating to the servo automatic gain control, a comparison result relating to the jitter, and a comparison result relating to the bias.

11. A method of controlling a disk drive, comprising:
determining a reference value of a predetermined parameter of the disk drive;
measuring a value of the parameter during a writing operation of the disk drive;
comparing the measured value of the parameter with the reference value; and
determining the occurrence of head-disk interference (HDI) based on a result of the comparison.

12. The method of claim 11, wherein the parameter comprises at least one of a servo automatic gain control, a jitter representing a difference between a current velocity and a target velocity of a spindle motor of the disk drive, and a bias applied to a voice coil motor (VCM) of the disk drive.

13. The method of claim 12, wherein the occurrence of HDI is determined based on at least one of a comparison result related to a position error signal (PES) of the disk drive, a comparison result related to the servo automatic gain control, a comparison result relating to the jitter, and a comparison result related to the bias.

14. The method of claim 11, wherein determining the reference value comprises:
iteratively writing predetermined data in a track of the disk drive and then decreasing a flying height of a head of the disk drive until HDI occurs; and
determining the reference value by measuring a value of the parameter during occurrence of the HDI.

15. A disk drive comprising:
a disk;
a head for writing data to the disk; and
a controller for controlling the head,
wherein the controller comprises:
a determination unit that determines a reference frequency and a reference amplitude from a first position error signal (PES) and determines a frequency and an amplitude from a second PES generated during a writing operation;
a comparison unit that compares the frequency with the reference frequency and outputs a comparison signal indicating a result of the comparison; and
a control signal generating unit that generates a control signal based on the comparison signal, and the control signal is used to control the head.

16. The disk drive of claim 15, wherein:
the first PES is measured while HDI is generated on a normal track of the disk drive;
the determination unit determines the reference frequency and the reference amplitude by performing a fast Fourier transform (FFT) on the first PES; and
the determination unit determines the frequency and the amplitude by performing an FFT on the second PES.

17. The disk drive of claim 15, wherein the control signal generating unit generates the control signal to increase a flying height of the head upon determining that a difference between the frequency and the reference frequency is less than or equal to a predetermined value and the amplitude is greater than the reference amplitude.

18. The disk drive of claim 15, wherein the determination unit determines a reference value related to a predetermined parameter of the disk drive, and measures a value of the predetermined parameter during a writing operation; and
the comparison unit compares the measured value of the parameter with the reference value and outputs a comparison signal based on the comparison.

19. The disk drive of claim 18, further comprising:
a spindle motor for rotating the disk at a predetermined speed; and
a voice coil motor (VCM) for driving the head,
wherein the parameter comprises at least one of a servo automatic gain control, a jitter representing a difference between a current velocity and a target velocity of the spindle motor, and a bias applied to the VCM.

20. The disk drive of claim 19, wherein the control signal generating unit generates the control signal using at least one of a comparison result related to the second PES, a comparison result related to the servo automatic gain control, a comparison result related to the jitter, and a comparison result related to the bias.
